(19) United States
(12) Patent Application Publication
(10) Pub. No.: US 2019/0378128 A1
(43) Pub. Date: Dec. 12, 2019

(54) Cryptographic Contract Payment and Dispute Resolution System

(71) Applicants: Charles L. Moore, San Francisco, CA (US); Mark Edwards, Hertfordshire (GB); Sachin Saxena, Hertfordshire (GB)

(72) Inventors: Charles L. Moore, San Francisco, CA (US); Mark Edwards, Hertfordshire (GB); Sachin Saxena, Hertfordshire (GB)

(73) Assignee: ROCKET LAWYER INCORPORATED, San Francisco, CA (US)

(21) Appl. No.: 16/436,885

(22) Filed: Jun. 10, 2019

Related U.S. Application Data
(60) Provisional application No. 62/682,756, filed on Jun. 8, 2018.

(51) Int. Cl. G06Q 20/38; G06Q 20/36

(52) U.S. Cl. CPC G06Q 20/3825; G06Q 2220/00; G06Q 20/3678

(57) ABSTRACT

Disclosed embodiments may include systems and methods for the creation of self-executing smart contract computer programs (“Smart Contracts”) recorded on one or more blockchains as “on chain” contracts comprising machine extracted terms from non-blockchain recorded (“off chain”) digital contracts. Disclosed systems include means of conversion of fiat currencies to cryptographically generated and unique tokens (“crypto-tokens”) at a pre-set market exchange rate that does not fluctuate after the initial exchange and until directly exchanged back to the original fiat currency. Disclosed systems facilitate automated digital performance of the payment terms of off-chain contracts via on-chain smart contracts and crypto-tokens. Upon the performance of an on-chain self executing smart contract, the system will automatically release crypto-tokens or other consideration that is either held in escrow or held by an interested party. In case of a contract dispute, the system will issue a judgment using electronic data, pre-defined rules and machine logic.

### CROSS-REFERENCE TO RELATED APPLICATIONS

This utility patent application claims priority of and the benefit of provisional patent application 62/682,756 filed on Jun. 8, 2018 the contents of which are incorporated herein by reference.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to means and methods of crypto-tokenized monetary exchanges and fund transfers memorialized with machine created immutable distributed blockchain records. More particularly, the invention relates to machine systems and methods sometimes used for facilitating contract performance in the form of crypto-tokenized electronic funds deposits, balances, escrow, payments, scheduled payments, contingent payments, transfers and machine-based dispute resolution according to the terms of electronic legal contracts generated and/or managed by the disclosed systems over a network or a plurality of networks, with such networks including the Internet. Disclosed embodiments include means and methods of creating and facilitating digital performance of on-chain self executing smart contracts. Disclosed embodiments include use of expanded network systems often called Internet of Things or IoT, mechanically or electrically fixed and tangible components such as hash codes, tokens and IDs or identification strings that enable identity portability. The term “on-chain” may mean a component such as an on-chain self executing smart contract that is stored, defined, executed or otherwise associated with one or more blockchains. A blockchain or related components such as an on-chain self executing smart contract may take any one of many physical forms, such as immutable electronic records, non-transitory media, original, fixed, immutable hash codes, and other physical forms and specialized computing systems.

### (2) Description of the Related Art

The known related art fails to anticipate or disclose the principles of the presently disclosed embodiments.

In the related art, U.S. Pat. No. 8,255,800 by Rocket Lawyer Incorporated is known and may be considered to be in the same field of various subsets of the disclosed embodiments. But, the presently disclosed embodiments represent unobvious departures and improvements to the known related art. For example, the known prior art of Rocket Lawyer Incorporated does not disclose, anticipate or support performance of the financial consideration terms of contracts created in a machine environment. Moreover, the prior art fails to disclose or anticipate the disclosed embodiments of machine based payments in reaction to machine based contract dispute resolution or machine based payments in reaction to undisputed contract performance. Thus, there is a need in the art for the presently disclosed embodiments.

### BRIEF SUMMARY OF THE INVENTION

The present invention overcomes shortfalls in the related art by presenting an unobvious and unique combination and configuration of methods, systems and components to mechanically or electronically resolve commercial or contractual disputes and mechanically transfer payments by mechanically created crypto-tokenized exchanges of system generated currencies or other means of payments.

The disclosed embodiments overcome shortfalls in the related art by facilitating contract performance and automatically compensating parties by use of a machine based ecosystem wherein payments are triggered in reaction to full or partial contract performance.

These and other objects and advantages will be made apparent when considering the following detailed specification when taken in conjunction with the drawings.

### BRIEF DESCRIPTION OF THE DRAWINGS

FIG. 1 depicts a schematic view of machine based contract creation

FIG. 2 depicts a schematic view of smart contract recording of tokenization of fiat currency

FIG. 3 depicts a schematic view of the withdrawal of crypto tokens from the system

FIG. 4 depicts a schematic view of machine-based contract settlement and dispute resolution

### REFERENCE NUMERALS IN THE DRAWINGS

100 a disclosed embodiment in general
200 party X
202 party X wallet
203 party X performance
210 party Y
212 party Y wallet
213 party Y performance
300 off chain contract
320 digital signing
340 payment terms extraction
350 smart contract with payment terms
352 smart contact with token FX rate
360 smart contract with party X identification
370 smart contract with party Y identification
400 blockchain system comprising elements of the smart contracts
500 escrow
520 crypto tokens held in escrow or in reserve during performance of an off chain legal contract
600 network exchange system
700 data
800 system evaluation of contract execution
820 release of tokenized funds to the wallet of a prevailing party to a dispute

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

Any and all the above references and U.S. patents and applications are incorporated herein by reference. Aspects of the invention can be modified, if necessary, to employ the systems, functions and concepts of the various patents and applications described above to provide yet further embodiments of the invention.

The disclosed embodiments include a system and method of facilitating and monitoring machine based contract formation, performance monitoring, triggering of payments, payment and when needed, dispute resolution. In the handling of money, disclosed embodiments include the use of traditional currency as well as floating and non-floating crypto tokens.

Floating crypto tokens may be implemented via crypto-tokenized exchange of financial consideration. Fiat currencies (e.g., USD, GBP, EUR) may be exchanged for blockchain-based crypto-tokens at a fixed or market exchange rate. The use of floating crypto tokens or other blockchain currencies may be used in other applications such as raising capital or providing investment opportunities.

Disclosed embodiments include the use of non-floating crypto-tokens that may be purchased with a selected fiat currency and then later redeemed with the selected fiat currency so as to avoid fluctuations in crypto token exchange rates.

In a floating crypto token embodiment, the exchange rate at the time of exchange is recorded into the blockchain as part of a Smart Contract. The term Smart Contract may also include “on-chain self executing smart contract.” The Smart Contract records the right of the party exchanging fiat currency to “put” or re-sell the crypto-token within the network at the same exchange rate of the original purchase. The Smart Contract supports one or more blockchain Wallets to facilitate withdrawal of fiat currency through either execution of the Put Option, in whole or in part, or sale of some or all of the crypto-tokens governed by the Smart Contract in a third party transaction outside the network. Token transfers as consideration for centralized, off blockchain contracts are facilitated by the system and such token transfers are also tracked and auto-recorded within the context of the on-chain Smart Contract governed Wallets. Parties receiving crypto-tokens via transfers within the network also receive the right to re-sell the crypto-token within the network at the same exchange rate of the original purchase, or to sell some or all of the transferred crypto-tokens in a third party transaction outside the network.

In either floating or non-floating crypto token implementations, the system is capable of holding in escrow or restricting access to tokenized balances according to off-chain, network-based legal contract terms between network users who are parties to said off-chain legal contracts according to the terms of the off-chain legal contract. Execution of off-chain legal contracts is validated and recorded by jurisdictionally compliant cryptographic, digital signatures that are recorded on-chain as Smart Contracts. Such Smart Contracts include the payment terms automatically extracted from the off-chain, network-based legal contract. In order to digitally sign, the IDs of the parties, may be stored on the blockchain as Smart Contract conditions. Upon successful performance of the off-chain, network-based legal contract, crypto-tokens are automatically transferred between parties via network compatible electronic Wallets in accordance with the payment term conditions programmed in the Smart Contract. Disclosed embodiments include the use of various means of ID verification that may or may not use smart contracts. ID verification or IDs may take many forms such as tangible forms of electronic or mechanical tokens, hash codes, encrypted keys with such IDs existing independently or residing within or upon a blockchain, off chain contract, self executing smart contract or other system component.

Disputes of contracts may be resolved via machine-based logic without human intervention by evaluation of data according to pre-set rules and machine-logic. Financial settlement of disputes is accomplished by the automated release of tokenized funds into the electronic Wallet of the prevailing party or parties to the dispute. Undisputed transactions are automatically processed and tokenized funds released to electronic Wallets of the parties, according to the on-chain payment terms derived or extracted from the off-chain contract terms by the system.

Disclosed embodiments may or may not include some or all of the following steps:

Step 1: Off chain contract is created via electronic document assembly or file upload to the network.

Step 2. Contract is reviewed, negotiated and executed by the parties via jurisdictionally compliant digital signatures and further recorded as an on-chain Smart Contract, subject to Smart Contract ID verification.

Step 3. Payment terms automatically extracted from the contract are recorded on-chain as a Smart Contract.

Step 4. Parties may optionally purchase crypto-tokens pursuant to on-chain Smart Contracts containing exchange rate and option to either re-sell (put) crypto-tokens to the network operator or other purchaser at the original exchange rate or sell crypto-tokens in third party transactions at market exchange rates. The use of non-floating crypto tokens may be implemented wherein a selected fiat currency is used for the purchase and redemption of crypto tokens.

Step 5. Network automatically reserves and releases tokens to off-chain contract parties according to off-chain contract terms recorded in on-chain Smart Contracts.

Step 6. Prior to the release of tokens described in Step 5, parties may dispute the off-chain contract performance.

Step 7. The Network Operator may determine the winner and loser of the dispute (if any) described in Step 6 by evaluating data according to machine logic, or the system will automatically determine a winner or otherwise provide a dispute judgment or judgement of contract or party performance by predefined system rules and/or machine logic

Step 8. The Winner of the dispute, if applicable, is awarded the disputed tokens without human intervention.

Disclosed embodiments include both the use and non-use of escrow accounts.

Disclosed embodiments include systems and methods of facilitating machine based contract performance and dispute resolution via crypto-tokenized exchange of financial consideration.

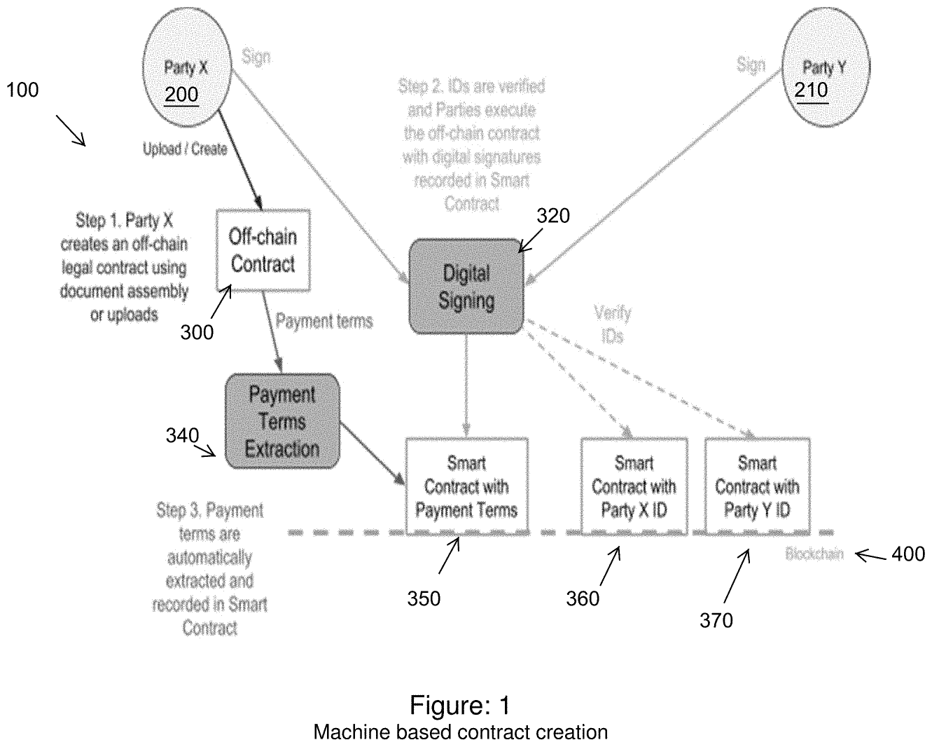

Referring to FIG. 1, a system or method 100 may include a first party or party X 200 performing a first step of creating an off-chain legal contract using documents physically assembled, electronically assembled and/or uploaded into a disclosed system. The results of which, or the resulting artifact may take the form of an off chain contract 300.

A second step illustrated in FIG. 1 may include the formation of a smart contact which may be formed by the verification of IDs or identifications followed by the parties executing or otherwise attesting to an off chain contract 300, the execution may be effected by use of digital signatures. This second step of FIG. 1 may be considered a digital signing 320 which may include the participation of a first and second party, such as a party X 200 and a party Y 210.

A third step illustrated in FIG. 1 may include a payment terms extraction 340 which may include the machine extraction of payment terms with such extracted terms being recorded upon a smart contract. The smart contract may take the form of a digital record and may take the form or be composed of a plurality of modules or blockchain elements such as a smart contract with payment terms 350 a smart contract with party X's ID 360 and a smart contract with party Y's ID 370. A blockchain 400 may comprise an electronic system or record comprising smart contracts and/or elements of smart contracts.

In general, FIG. 1 may be considered to depict a machine based contract creation system.

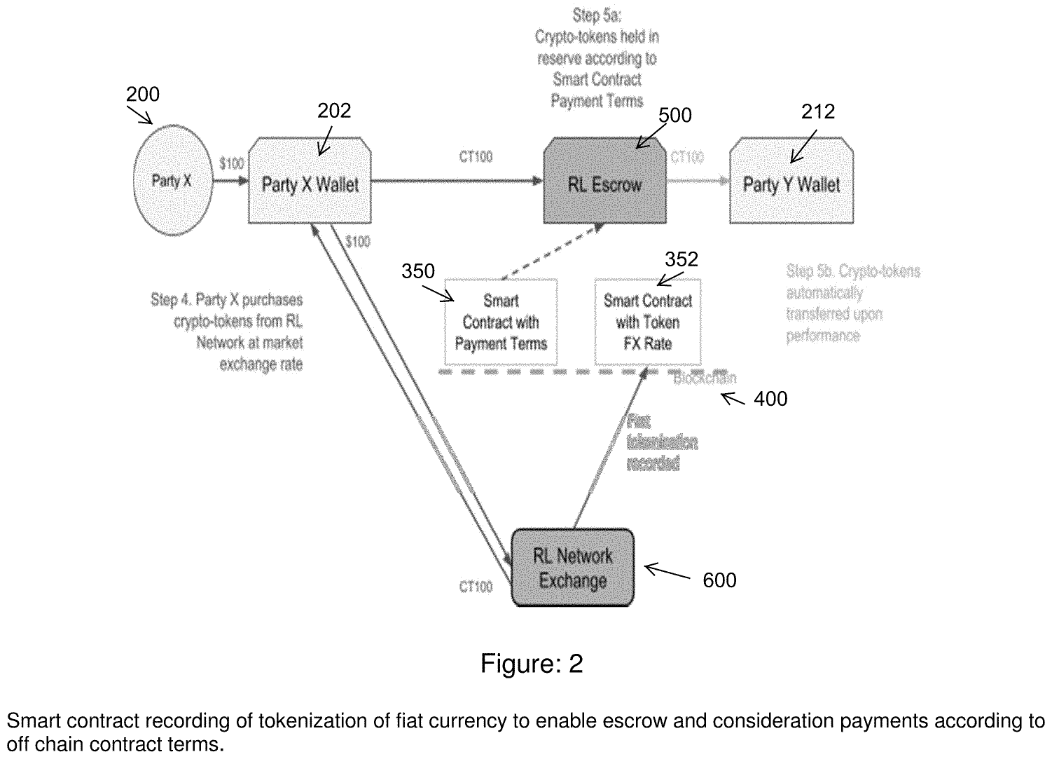

Referring to FIG. 2, disclosed system steps or system components are disclosed and/or illustrated wherein an escrow is enabled by smart contract recording of tokenization of fiat currency and payments are executed pursuant to off chain contract terms. FIG. 2 includes a system or method step four wherein a first party, such as party X 200 purchases crypto tokens from the disclosed network or system or an “RL Network” such as a Rocket Lawyer Network at a market exchange rate or other rate. Thus, for example, party X 200 may infuse their party X wallet 202 with $100 dollars with the $100 dollars flowing to an exchange network 600 and in exchange, the party X wallet receives a 100 units of CT or crypto currency or crypto Tokens.

In a 5^{th} step or 5a step illustrated in FIG. 2, the crypto tokens or CT purchased by party X are transferred into an escrow 500 such as a system owned or system controlled escrow such as a Rocket Lawyer Escrow.

A first tokenization may be recorded from the network exchange 600 to the blockchain 400 with the blockchain hold or defines a smart contract with payment terms 350 and or a smart contract with a Token FX rate 352.

In a 6^{th} step or 5b step illustrated in FIG. 2 crypto tokens may be transferred by machine upon contract performance. For example, a command from a smart contract with payment terms 350 may be sent to the escrow 500 causing the escrow to send cryptocurrency to the party Y wallet 212.

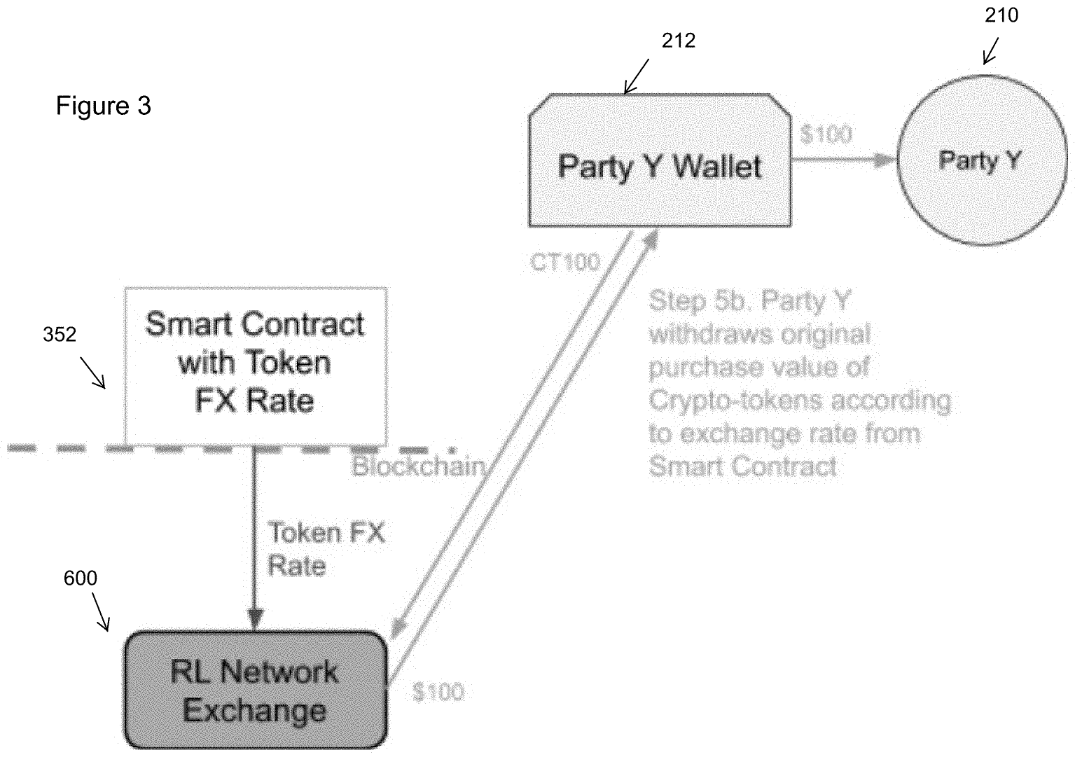

Referring to FIG. 3, a second party or a party Y 210 withdraws original purchase value of crypto tokens according of and exchange rate from the on-chain self executing smart contract.

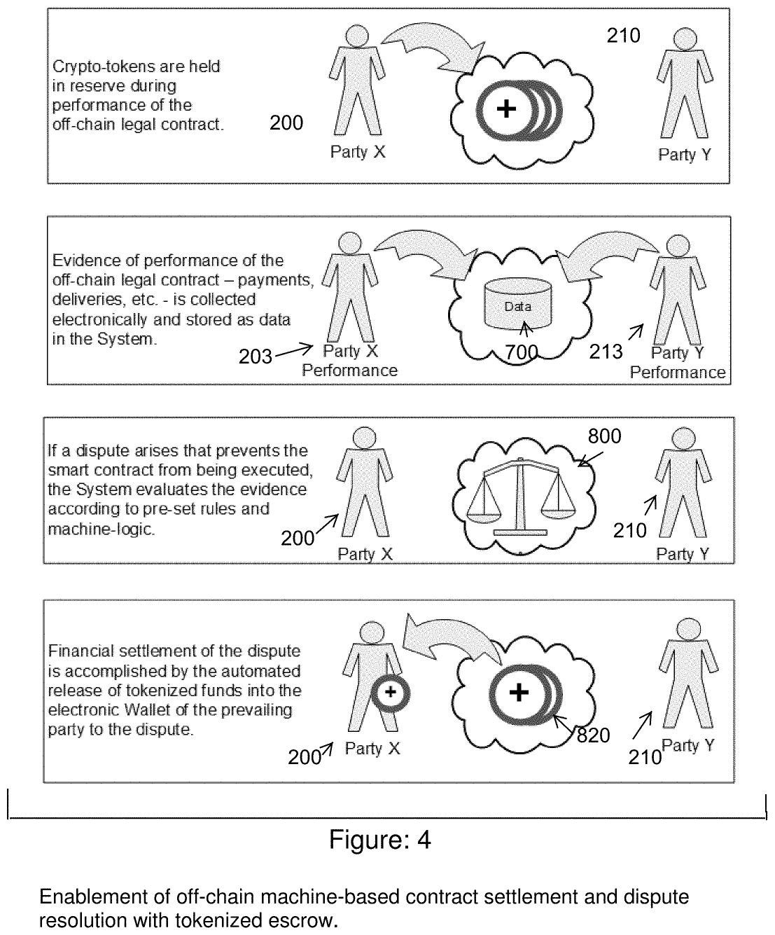

Referring to FIG. 4, methods, systems and components are disclosed to enable off chain machine based contract settlement and dispute resolution with a tokenized escrow system.

In FIG. 4, a first party, or party x 200 may deposit crypto tokens into an escrow or reserve 520 wherein crypto tokens or other consideration is held in reserve during performance of an off chain legal contract.

In another step of FIG. 4, evidence of performance of party X, such as evidence of performance of an off chain legal contract, wherein such evidence may include payments, deliveries and other acts relevant to the legal contract, with such evidence collected or inputted electronically and stored as data 700 within a disclosed system. Both the performance of party X 203 and performance of party Y 213 and other input sources may be inputted as data.

In a further step illustrated in FIG. 4, in the event party X 200 or party Y 210 have a dispute that prevents the smart contract from being executed, a disclosed system evaluates the evidence by use of pre-determined system rules and machine-logic in a system of evaluation of contract execution. 800.

In a further step illustrated in FIG. 4 one of the parties, such as either party X 200 or party Y 210 are awarded tokenized funds to their respective electronic wallet upon the settlement of judgement of the dispute as described above. The release of tokenized funds 820 may be automated and/or dependent upon machine actions.

Disclosed embodiments include means and methods of monitoring and facilitating numerous aspects of contract performance wherein such performance or related acts may be triggered or executed by machine. Disclosed embodiments include the machine execution of contract performance that may take digital or electronic action such as: payments from one party to another party, delivery and acceptance of services, delivery and acceptance of goods or even the absence of a triggering event (e.g., a tenant occupies a rental property and payments are automatically sent to the landlord every month for the term of the lease agreement).

Smart contracts, which may include specialized digital files stored upon blockchain systems and may be considered and perform as a self-executing smart contract. A smart contract herein may electronically or mechanically automatically trigger one performance element, based on the smart contract becoming “aware” of the performance of another performance element that was a condition to the second.

The machine implemented and automatic nature of the disclosed smart contracts and/or on-chain self executing smart contracts may have the following performance attributes: 1) time based conditional. If the contract calls for a payment to be made on a certain date, absent another condition, like a dispute or default, then, the Smart Contract will automatically initiate the payment on the date specified, whenever the “dispute” or “default” condition has not been triggered within the conditional time frame; 2) a network enabled device relays to the Smart Contract that an asset has been received by one party from another party or has arrived at a contractually agreed location checkpoint and a payment is triggered based on the condition that the asset arrived per the terms stored in the Smart Contract.

Disclosed embodiments include mechanically or electrically fixed and tangible components such as hash codes, tokens and IDs or identification strings that enable identity portability. Disclosed embodiments include the novel creation of physically or electronically fixed and tangible items such as tokens and/or hash codes.

The tokens and/or hash codes may be unique and created by the system as terms, payments and other contract and contract performance elements that are automatically extracted on off chain contract and disposed upon self executing smart contracts, with the self executing smart contracts sometimes residing upon or embedded within an underlying blockchain system 400, such as the system shown in FIG. 1.

In further review of FIG. 1, payment terms 340 may be automatically extracted from an off chain contract 300, with the payment terms transformed into unique electronic and fixed tokens and/or hash tags forming a part of a smart self executing contract with payment terms 350 being one tangible component, with the self executing contract sometimes comprising several electronic or mechanical or otherwise tangible components such as, a party X ID 360 and a party Y ID, with such tangible components residing upon or integrated with the tangible elements of the blockchain 400.

Other system components such as a cryptocurrency tokens, or crypto tokens 520, token FX rates 352, digital signatures, evidence of party performance 203, 213, electronic wallets 202, 212, and other system components may all take the form of specialized, fixed and tangible tokens and/or hash codes.

Items

Disclosed embodiments may include the following items:

1. A method of contract formation, electronic contract performance monitoring, electronic payment, and electronic contract performance using smart contract defined and created upon an electronic blockchain system the method comprising the steps of:

a) a network and computer creating a contract by file upload through the network to the computer;

b) digital signatures by parties to the contract uploaded via the network into the computer, the digital signatures recorded as an on-chain smart contract,

c) payment terms of the contract are extracted by the computer with the extracted payment terms then added to the on-chain smart contract;

d) the computer issues crypto tokens to the parties after receiving consideration from the parties;

e) to the on-chain smart contract receiving data confirming performance of the on-chain smart contract, the computer releases crypto tokens to one or more of the parties.

2. The method of item 1 further including the step of:

a) the on-chain smart contract comprising an exchange rate for the crypto currency as compared to a fiat currency and the step of the on-chain smart contract offering an option to a party to option to either re-sell (put) crypto-tokens to a system operator at the original exchange rate or sell crypto-tokens in third party transactions at market exchange rates.

3. A system of contract formation and electronic contract performance using an on-chain smart contract, the on-chain smart contract defined and created upon an electronic blockchain system the system comprising:

a) a contract created by a computer and electronic network, the contract formed by uploads over the electronic network to the computer;

b) an on-chain smart contract comprising contract terms extracted by the computer from the contract, the on-chain contract further comprising digital signatures of the parties to the contract;

c) crypto tokens issued by the computer to one or more of the parties to the contract in exchange for consideration received from one or more of the parties;

d) a release of crypto tokens to one or more of the parties in response to the on-chain smart contract receiving data confirming performance of the on-chain smart contract.

4. The system of item 4 wherein the on-chain smart contract contains an exchange rate and option transmitted to one or more of the parties, with the option comprises means to either re-sell (put) crypto-tokens to the network operator at the original exchange rate or sell crypto-tokens in third party transactions at market exchange rates.

5. The method of item 1 using tangible tokens to memorialize the self-executing smart contract.

The detailed description of embodiments of the invention herein is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

What is claimed is:

1. A method of contract formation, electronic payment, and contract performance using an on-chain self executing smart contract, the on-chain self executing smart contract defined and created upon an electronic block-chain system, the method comprising the steps of:
a) a network and computer creating an off chain contract by either network-based digital document assembly or file upload through the network to the computer;
b) digital signatures by parties to the off chain contract created or uploaded via the network into the computer, the digital signatures recorded as part of the on-chain self executing smart contract;
c) payment terms of the off chain contract are extracted by the computer with the payment terms then added as conditions to the on-chain self executing smart contract computer program;
d) the computer generates, issues and records crypto tokens after receiving consideration from the parties; and
e) in response to the on-chain self executing smart contract receiving data confirming performance of the on-chain self executing smart contract, the computer releases crypto tokens to one or more of the parties.

2. The method of claim 1 further including the step of:
a) the on-chain self executing smart contract comprising an exchange rate for the crypto tokens as compared to a fiat currency and the step of the on-chain self executing smart contract offering an option to a party to either re-sell (put) crypto tokens to a system operator at the original exchange rate or sell crypto-tokens in third party transactions at market exchange rates.

3. The method of claim 1 further including the step of using non-floating exchange rate crypto tokens.

4. The method of claim 1 further including the step of the computer accepting data pertaining to a dispute between the parties and the step of the computer issuing a judgment to the dispute by use of predefined rules and machine logic.

5. The method of claim 1 further including the step of using specialized tokens to memorialize terms of the on-chain self executing smart contract.

6. The method of claim 1 further including the step of extracting of contract terms from the off chain contract to create tokens upon the self executing on-chain smart contract with the tokens memorializing the terms of the off chain contract.

7. The method of claim 6 further including the step of creating unique hash codes as a means of memorializing contract terms of the off chain contract.

8. The method of claim 6 further including the step of using tokens of a tangible and static electronic form.

9. The method of claim 6 further including the step of using static hash codes in place of tokens.

10. A system of contract formation, contract performance, electronic payment, and contract settlement using an on-chain self executing smart contract, the on-chain self executing smart contract stored upon an electronic block-chain system, the system comprising:
a) an off chain contract formed by one or more uploads over an electronic network to a computer;
b) an on-chain self executing smart contract comprising contract terms extracted by the computer from the off chain contract, the on-chain self executing smart contract further comprising digital signatures obtained from parties to the off chain contract;
c) crypto tokens issued by the computer in response to consideration transmitted to the computer by one or more of the parties;
d) a release of crypto tokens to one or more of the parties in response to the on-chain self executing smart contract receiving data confirming performance of the on-chain self executing smart contract.

11. The system of claim 10 wherein the on-chain self executing smart contract contains an exchange rate and option transmitted to one or more of the parties, where the option allows a party to either re-sell (put) crypto-tokens to the network operator at the original exchange rate or sell crypto-tokens in third party transactions at market exchange rates.

12. The system of claim 10 further including input into the on-chain self executing smart contract of a dispute between the parties and the system issuing a judgment resolving the dispute by use of predefined rules and machine logic.

13. The system of claim 10 wherein the crypto tokens are based upon a single fiat currency in both purchase and redemption by one or more of the parties.

14. The system of claim 10 wherein the crypto tokens are comprised of a tangible and static electronic form.

15. The system of claim 10 wherein the contract terms are memorialized by tokens of a tangible and static form and the tokens reside upon a block-chain.
